(19) United States
(12) Patent Application Publication
(10) Pub. No.: US 2013/0344337 A1
(43) Pub. Date: Dec. 26, 2013

(54) HOLLOW MICROSPHERES

(71) Applicants: Gang Qi, Stillwater, MN (US); Kenton D. Budd, Woodbury, MN (US); Michael J. Staiger, Hastings, MN (US); Jean Ann Tangeman, Minneapolis, MN (US); Larry Ray Visser, Oakdale, MN (US)

(72) Inventors: Gang Qi, Stillwater, MN (US); Kenton D. Budd, Woodbury, MN (US); Michael J. Staiger, Hastings, MN (US); Jean Ann Tangeman, Minneapolis, MN (US); Larry Ray Visser, Oakdale, MN (US)

(73) Assignee: 3M Innovative Properties Company, St. Paul, MN (US)

(21) Appl. No.: 14/003,589

(22) PCT Filed: Feb. 24, 2012
(86) PCT No.: PCT/US12/26434

§ 371 Date: Sep. 6, 2013

Related U.S. Application Data
(60) Provisional application No. 61/449,808, filed on Mar. 7, 2011.

(51) Int. Cl. C03C 11/00

(52) U.S. Cl. CPC C03C 11/002
USPC 428/402; 65/21.4

(57) ABSTRACT

There is provided hollow microspheres comprising: at least 45 wt % of recycled glass based on the total weight of a feed composition from which the hollow microspheres are derived, wherein the hollow microspheres have a density of less than 1.25 g/cm³, strength at 20% volume reduction greater than 20 MPa and have a substantially single cell structure. There is also provided hollow microspheres comprising: a blend of recycled glass and glass feed, wherein the hollow microspheres have a density of less than 1.25 g/cm³ and are made from a feed composition that is essentially free of an added effective blowing agent. There is provided a method for making hollow microspheres.

The present disclosure relates to hollow microspheres. The present disclosure also relates to a spray drying process useful for making hollow microspheres.

### SUMMARY

In one aspect, the present disclosure provides hollow microspheres comprising: at least 45 wt % of recycled glass based on the total weight of a feed composition from which the hollow microspheres are derived, wherein the hollow microspheres have a density of less than 1.25 g/cm³, strength at 20% volume reduction greater than 20 MPa and have a substantially single cell structure.

In another aspect, there is also provided hollow microspheres comprising: a blend of recycled glass and other glass feed, wherein the hollow microspheres have a density of less than 1.25 g/cm³ and are made from a feed essentially free of an added effective blowing agent.

In yet another aspect, there is provided a method of making hollow microspheres comprising: providing a feed composition comprising recycled glass particles, forming an aqueous dispersion of recycled glass particles and at least one of boric acid and boron oxide, spray-drying the aqueous dispersion to form spherical glass agglomerates, and heating the agglomerates to form hollow microspheres, wherein the hollow microspheres have a substantially single cell structure.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 is an optical microscope image of single cell structure hollow microspheres according to Example 6.

### DETAILED DESCRIPTION

The term “glass” as used herein includes all amorphous solids or melts that can be used to form amorphous solids, where the raw materials used to form such glass includes various oxides and minerals. These oxides include metal oxides.

The term “recycled glass” as used herein means any commonly available waste glass. Recycled glass useful in the present disclosure includes previously manufactured and used silicate glass, such as, for example, soda lime silicate glass. Soda lime silicate glass is typically used in the manufacturing of glass bottles, glass windows and the like. The term “glass frit” as used herein means a suitable glassy material, typically examples include those described in U.S. Pat. Nos. 2,978,340 (Veatch et al.); 3,030,215 (Veatch et al.); 3,129,086 (Veatch et al.); and 3,230,064 (Veatch et al.); 3,365,315 (Beck et al.); and 4,391,646 (Howell), the disclosures of which are incorporated herein by reference in their entirety.

The term “glass feed” means recycled glass, milled and optionally classified glass frit, and/or combinations thereof used to produce hollow microspheres.

The term “feed composition” means glass feed combined with all other batch components, such as metal oxide powders, and small amounts of additives such as binders

Certain types of hollow microspheres and methods for making them have been disclosed in various references. For example, some of these references disclose a process of making hollow microspheres using simultaneous fusion of glass-forming components and expansion of the fused mass. Other references disclose heating a glass composition containing an inorganic gas forming agent, or blowing agent, and heating the glass to a temperature sufficient to liberate the blowing agent. Still other references disclose a process including pulverizing a material by wet pulverization to obtain a slurry of a pulverized powder material, spraying the slurry to form liquid droplets, and heating the liquid droplets to fuse or sinter the powder material in order to obtain inorganic microspheres. Yet other references disclose a process for making low density microspheres by processing precisely formulated feed mixtures in an entrained flow reactor under partially oxidizing conditions with a carefully controlled time-temperature history. Hollow microspheres can be made from a variety of processes and materials, including, for example, perlite, spray dried sodium silicate, and flame formed glass particles. Often, the product made from these processes and materials is multicellular, weak, not chemically durable, or has other limiting characteristics. For some applications, consistently higher quality single cell microspheres are required. It is particularly desirable to obtain high strength to density ratios. To obtain high strength to density ratios, carefully tailored glass compositions, feed components, and/or blowing agents and particular process steps, such as pre-melting the batch composition, have been used. None of these processes consistently provide high quality, such as, for example, low density and high strength, hollow microspheres using a glass feed comprising large amounts of recycled glass.

The present disclosure provides high quality hollow microspheres made from a feed composition comprising recycled glass. The term “high quality” as used herein means hollow microspheres having a substantially single cell structure, a density of less than 1.25 g/cm³, and a strength at 20% volume reduction greater than 20 MPa. In some embodiments, high quality hollow microspheres are made from a feed essentially free of added effective blowing agent. As described above, hollow microspheres are typically made from a carefully tailored glass feed composition. Therefore it is unexpected that high quality hollow microspheres can be obtained when using a feed composition comprising at least 45 wt % of recycled glasses that were originally designed for applications other than hollow microspheres.

Hollow microspheres (expanded microspheres), having a mean diameter of less than about 100 micrometers, have wide utility for many purposes, several of which require certain size, shape, density and strength characteristics. For example, hollow microspheres are widely used in industry as additives to polymeric compounds where they may serve as modifiers, enhancers, rigidifiers, and/or fillers. Generally, it is desirable that the hollow microspheres be strong to avoid being crushed or broken during further processing of the polymeric compound, such as by high pressure spraying, kneading, extrusion or injection molding. It is desirable to provide a method for making hollow microspheres that allows for control over the size, shape, density and strength of the resulting hollow microspheres.

Hollow microspheres are typically made by heating milled frit, commonly referred to as “feed” that contains a blowing agent. The blowing agent is typically present in the glass composition in an amount greater than about 0.12 wt % based on the total weight of the glass composition. Known methods for making hollow microspheres include the steps of: glass melting, glass frit milling, and flame formation of hollow microsphere. The key to this process is that the glass composition used to form the hollow microsphere must include a certain amount of a blowing agent prior to formation of the hollow microsphere using a flame. Blowing agent is typically a compound or composition that, when heated, liberates a blowing gas by one or more of combustion, evaporation, sublimation, thermal decomposition, gasification or diffusion. Blowing agents are also referred to as foaming agents or expanding agents. Structurally or chemically bound water has been described as a blowing agent; however, without wishing to be bound by theory, it is believed that when using relatively higher melting glass compositions, structurally/chemically bound water is removed too early in the process to be an effective blowing agent. The use of blowing agents that are not effective blowing agents may produce malformed bubbles and/or solid beads. As a result, not all compounds or components that liberate gas are effective blowing agents for the purpose of forming high quality hollow glass microspheres. Effective blowing agents release gas at a specific rate and temperature to interact with the molten glass and create hollow cavities therein, thus forming hollow microspheres. Pre-dissolved sulfur or sulfate is known as an effective blowing agent, but generally has required careful processing of custom melted glass. Addition of sulfates to finely milled glass component mixtures has also been described, and generally requires very specific, highly tailored glass compositions for successful bubble formation. Lower temperature gas formers such as compounds with structurally/chemically bound water, combustible organics, and carbon containing materials could potentially be useful, but might also be relatively ineffective or even interfere with glass melting and homogenization in a flame, resulting in lower quality bubbles. In some of these methods, it is necessary to melt the glass composition twice, once during batch melting to dissolve the blowing agent in the glass and another time during formation of the hollow microsphere. Because of the volatility of the blowing agent in the glass composition, the batch melting step is limited to relatively low temperatures during which the batch composition becomes very corrosive to the refractory of melting tanks used for the batch melting step. The batch melting step also requires a relatively long time and the sizes of the raw material particles used in the batch melting step must be kept small. These issues result in increased cost to and potential impurities in the resulting hollow microspheres. It is desirable to provide a method for making hollow microspheres that is essentially free of a blowing agent. As such, the present disclosure provides a method for making hollowing microspheres in which no effective blowing agent, such as pre-dissolved sulfur or sulfate, combustible organics, and carbon containing materials, is added during the feed glass melting and glass frit milling steps.

Feed useful in the present disclosure may be prepared, for example, by crushing and/or milling soda lime silicate recycled glass. In some embodiments, the feed contains recycled glass blended with other types of suitable components, such as, for example, other types of suitable glasses and/or individual oxide components. Exemplary other types of suitable glass useful for blending with recycled glass for the presently disclosed feed comprises from 50 to 90 percent of SiO₂, from 2 to 20 percent of alkali metal oxide, from 1 to 30 percent of B₂O₃, from 0 to 0.12 percent of sulfur (for example, as elemental sulfur), from 0 to 25 percent divalent metal oxides (for example, CaO, MgO, BaO, SrO, ZnO, or PbO), from 0 to 10 percent of tetravalent metal oxides other than SiO₂ (for example, TiO₂, MnO₂, or ZrO₂), from 0 to 20 percent of trivalent metal oxides (for example, Al₂O₃, Fe₂O₃, or Sb₂O₃, from 0 to 10 percent of oxides of pentavalent atoms (for example, P₂O₅ or V₂O₅), and from 0 to 5 percent fluorine (as fluoride) which may act as a fluxing agent to facilitate melting of the glass composition. In some embodiments, other suitable glass compositions useful for blending with recycled glass for the presently disclosed feed can be made from 485 g of SiO₂, 90% smaller than 68 μm (obtained from US Silica, West Va., USA), 114 g of Na₂₀.2B₂O₃, 90% smaller than 590 μm, 161 g of CaCO₃, 90% smaller than 44 μm, 29 g of Na₂CO₃, 3.49 g of Na₂SO₄, 60% smaller than 74 μm, and 10 g of Na₄P₂O₇, 90% smaller than 840 μm. In some embodiments, other suitable glass compositions useful for blending with recycled glass for the presently disclosed feed can be made from 68.02% of SiO₂, 7.44% of Na₂O, 11.09% B₂O₃, 12.7% of CaCO₃ and 0.76% of P₂O₅.

Boron oxide is a network-forming component of glass with a melting point of 450° C. and also a well known fluxing agent. Thus, boron oxide is molten at a temperature at which hollow glass microspheres are formed allowing it to create a skin (or coating) on an outer surface of the spray dried agglomerate from which the hollow microspheres are formed. Without being bound by theory, it is believed that because the boron oxide when added to the recycled glass reduces the melting point of the agglomerate and forms such a skin, entrapped gases and water are prevented from escaping the spray dried agglomerate during formation of the hollow microspheres. The resulting hollow microspheres have substantially single cell structures and densities of less than 1.25 g/cm³ while being made from a feed essentially free of an effective blowing agent.

Additional ingredients are useful in feed compositions and can be included in the feed, for example, to contribute particular properties or characteristics (for example, hardness or color) to the resultant hollow microspheres. In some embodiments, the above mentioned feed compositions are essentially free of added effective blowing agent. The phrase “essentially free of added effective blowing agent” as used herein means less than 0.05 wt % (based on the total weight of the feed composition) or less than 0.12 wt %, in some embodiments less than 0.14 wt % or even less than 0.16 wt % based on the total weight of the glass of an effective blowing agent added to the feed composition.

The feed is typically milled, and optionally classified, to produce feed of suitable particle size for forming hollow microspheres of the desired size. Methods that are suitable for milling the feed include, for example, milling using a bead or ball mill, attritor mill, roll mill, disc mill, jet mill, or combination thereof. For example, to prepare feed of suitable particle size for forming hollow microspheres, the feed may be coarsely milled (for example, crushed) using a disc mill, and subsequently finely milled using a jet mill. Jet mills are generally of three types: spiral jet mills, fluidized-bed jet mills, and opposed jet mills, although other types may also be used.

In some embodiments, the feed for producing the hollow microspheres can be produced by combining a primary component, and optionally, a binding agent (binder) in an aqueous dispersion or slurry. Binding agents useful in the present disclosure are useful to intimately bind individual particles in the feed into an agglomerate. Exemplary binding agents useful in the present disclosure include those commercially available under the trade designation “CELLGUM” from Ashland Aqualon, Wilmington, Del. This aqueous dispersion is then dried to produce an agglomerated feed. As described above, the preferred embodiments of the present invention provide a method of forming a feed, which includes the steps of mixing and drying. The resultant feed is generally a substantially solid agglomerate mixture of its constituent materials.

Typically, the mixing step provides an aqueous dispersion or slurry, which is later dried. Mixing can be performed by any conventional means used to blend ceramic powders. Examples of preferred mixing techniques include, but are not limited to, agitated tanks, ball mills, single and twin screw mixers, and attrition mills. Certain mixing aids such as, surfactants may be added in the mixing step, as appropriate. Surfactants, for example, may be used to assist with mixing, suspending and dispersing the particles.

Drying is typically performed at a temperature in the range of about 30° C. to 300° C. Any type of dryer customarily used in industry to dry slurries and pastes may be used. In some embodiments, drying may be performed in a spray dryer, fluid bed dryer, rotary dryer, rotating tray dryer, pan dryer, or flash dryer. Preferably, drying is performed using a spray dryer. Spray dryers are described in a number of standard textbooks (e.g. Industrial Drying Equipment, C. M. van't Land; Handbook of Industrial Drying 2^{nd} Edition, Arun S. Mujumbar) and will be well known to the skilled person.

In addition to the aforementioned advantages, it is generally desirable to synthesize expanded microspheres having a predetermined average particle size and a predetermined, preferably narrow, particle size distribution. The use of a spray dryer in certain preferred embodiments of the present invention has been found to reduce the need for any sizing/classification of the feeds or, ultimately, the hollow microspheres. Spray drying has the additional advantage of allowing a high throughput of material and fast drying times. Hence, in a particularly preferred embodiment of the present invention, the drying step is performed using a spray dryer.

Particle size and particle size distribution can be affected by one or more of the following parameters in the spray drying process: inlet slurry pressure and velocity (particle size tends to decrease with increasing pressure); design of the atomizer (rotary atomizer, pressure nozzle, two fluid nozzle or the like) design of the gas inlet nozzle; volume flow rate and flow pattern of gas; and slurry viscosity and effective slurry surface tension.

Preferably, the aqueous slurry feeding the spray dryer comprises about 25 to 70 wt % solids, more preferably about 30 to 50 wt % solids.

Preferably, the dried feed particles have an average particle size in the range of about 5 to 100 microns, more preferably about 8 to 50 microns, more preferably about 10 to 30 microns. The particle size of the feed will be related to the particle size of the resultant hollow microsphere, although the degree of correspondence will, of course, only be approximate. If necessary, standard comminuting/sizing/classification techniques may be employed to achieve the preferred average particle size.

In addition to the ingredients described above, the aqueous dispersion may contain further processing aids or additives to improve mixing, flowability or droplet formation in the spray dryer. Suitable additives are well known in the spray drying art.

In the spray drying process, the aqueous slurry is typically pumped to an atomizer at a predetermined pressure and temperature to form slurry droplets. The atomizer may be one or a combination of the following: an atomizer based on a rotary atomizer (centrifugal atomization), a pressure nozzle (hydraulic atomization), or a two-fluid pressure nozzle where the slurry is mixed with another fluid (pneumatic atomization).

In order to ensure that the droplets formed are of a proper size, the atomizer may also be subjected to cyclic mechanical or sonic pulses. The atomization may be performed from the top or from the bottom of the dryer chamber. The hot drying gas may be injected into the dryer co-current or counter-current to the direction of the spraying.

By controlling the spray drying conditions, the average particle size of the feeds and the feed particle size distribution can be controlled. For example, a rotary atomizer can be used to produce a more uniform agglomerate particle size distribution than a pressure nozzle. Furthermore, rotating atomizers allow higher feed rates, suitable for abrasive materials, with negligible blockage or clogging. In some embodiments, a hybrid of known atomizing techniques may be used in order to achieve agglomerate feeds having the desired characteristics.

The atomized droplets of slurry are dried in the spray dryer for a predetermined residence time. The residence time can affect the average particle size, the particle size distribution and the moisture content of the resultant feeds. The residence time is preferably controlled to give the preferred characteristics of the feed, as described above. The residence time can be controlled by the water content of the slurry, the slurry droplet size (total surface area), the drying gas inlet temperature and gas flow pattern within the spray dryer, and the particle flow path within the spray dryer. Preferably, the inlet temperature in the spray dryer is in the range of about 120° C. to 300° C. and the outlet temperature is in the range of about 90° C. to 150° C.

Preferably, the amount of recycled glass comprises at least about 45 wt %, in some embodiments at least about 50 wt %, in some embodiments at least about 60 wt %, in some embodiments at least about 70 wt %, and in some embodiments up to and including 90 wt %, in some embodiments up to and including 95 wt % or even 100 wt %, where the weight percents are based on the total weight of the feed composition from which the hollow microspheres are derived.

Hollow microspheres made using the presently disclosed method have relatively low densities. In some embodiments, the presently disclosed hollow microspheres have a density of less than about 1.25 g/ml. In other embodiments, the presently disclosed hollow microspheres have a density of less than about 1.0 g/ml, less than about 0.9 g/ml, less than about 0.8 g/ml, or less than about 0.7 g/ml.

Hollow microspheres made using the presently disclosed method have relatively high strengths. In some embodiments, the presently disclosed hollow microspheres have strengths of greater than about 20 MPa at 20 percent volume reduction of hollow microspheres. In some embodiments, the presently disclosed hollow microspheres have strengths of greater than about MPa at 20 percent volume reduction of hollow microspheres. In still other embodiments, the presently disclosed hollow microspheres have strengths of greater than about 50 MPa at 20 percent volume reduction of hollow microspheres, greater than about 80 MPa at 20 percent volume reduction of hollow microspheres, greater than about 90 MPa at 20 percent volume reduction of hollow microspheres, or greater than about 100 MPa at 20 percent volume reduction of hollow microspheres.

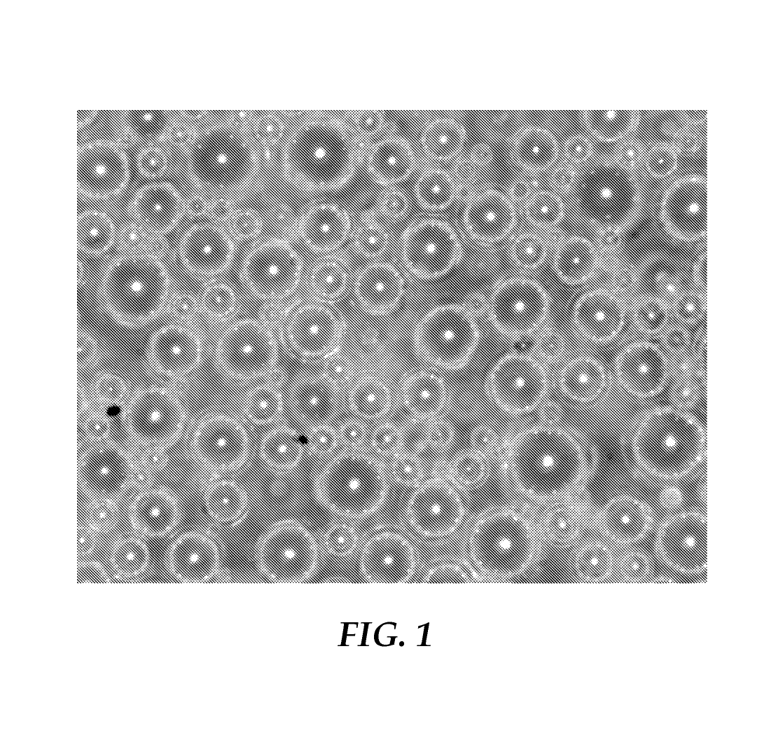

Hollow microspheres made using the presently disclosed method have substantially single cell structures. The term “substantially” as used herein means that the majority of the hollow microspheres made using the presently disclosed method have single cell structures. The term “single cell structure” as used herein means that each hollow microsphere is defined by only one outer wall with no additional exterior walls, partial spheres, concentric spheres, or the like present in each individual hollow microsphere. Exemplary single cell structures are shown in the optical images shown in FIG. 1.

The feed, produced by the method described above, is fed into a heat source (e.g. natural gas/air or natural gas/air/oxygen flame) to produce hollow microspheres (expanded microspheres). The flame may be neutral, reducing or oxidizing. The natural gas/air and/or natural gas/air/oxygen ratio may be adjusted to yield hollow microspheres of varying densities and strengths. The feed is heated to a heating temperature that fuses the feed into a melt, reduces the viscosity of the melt, seals the surface of the feed and promotes expansive formation of gas within the melt to form microspheres. The heating temperature should also preferably maintain the melt at a temperature and time sufficient to allow the internal bubbles to coalesce and form a single primary internal void within the microspheres. The microspheres are then cooled, thus forming hollow glassy microspheres.

The hollow microspheres according to present disclosure may be used in a wide variety of applications, for example, in filler applications, modifier applications, containment applications or substrate applications. Hollow microspheres according to the preferred embodiments may be used as fillers in composite materials, where they impart properties of cost reduction, weight reduction, improved processing, performance enhancement, improved machinability and/or improved workability. More specifically, the hollow microspheres may be used as fillers in polymers (including thermoset, thermoplastic, and inorganic geopolymers), inorganic cementitious materials (including material comprising Portland cement, lime cement, alumina-based cements, plaster, phosphate-based cements, magnesia-based cements and other hydraulically settable binders), concrete systems (including precise concrete structures, tilt up concrete panels, columns, suspended concrete structures etc.), putties (e.g. for void filling and patching applications), wood composites (including particleboards, fibreboards, wood/polymer composites and other composite wood structures), clays, and ceramics. One particularly preferred use is in fiber cement building products.

The hollow microspheres may also be used as modifiers in combination with other materials. By appropriate selection of size and geometry, the microspheres may be combined with certain materials to provide unique characteristics, such as increased film thickness, improved distribution, improved flowability etc. Typical modifier applications include light reflecting applications (e.g. highway markers and signs), industrial explosives, blast energy absorbing structures (e.g. for absorbing the energy of bombs and explosives), paints and powder coating applications, grinding and blasting applications, earth drilling applications (e.g. cements for oil well drilling), adhesive formulations and acoustic or thermal insulating applications.

The hollow microspheres may also be used to contain and/or store other materials. Typical containment applications include medical and medicinal applications (e.g. microcontainers for drugs), micro-containment for radioactive or toxic materials, and micro-containment for gases and liquids.

The hollow microspheres may also be used in to provide specific surface activities in various applications where surface reactions are used such as substrate applications. Surface activities may be further improved by subjecting the microspheres to secondary treatments, such as metal or ceramic coating, acid leaching etc. Typical substrate applications include ion exchange applications for removing contaminants from fluid, catalytic applications in which the surface of the microsphere is treated to serve as a catalyst in synthetic, conversion or decomposition reactions, filtration where contaminants are removed from gas or liquid streams, conductive fillers or RF shielding fillers for polymer composites, and medical imaging.

Exemplary embodiments include the following:

Embodiment 1. Hollow microspheres comprising: at least 45 wt % of recycled glass based on the total weight of a feed composition from which the hollow microspheres are derived, wherein the hollow microspheres have a density of less than 1.25 g/cm³, strength at 20% volume reduction greater than 20 MPa and have a substantially single cell structure.

Embodiment 2. Hollow microspheres according to embodiment 1 wherein the hollow microspheres are produced from a feed composition essentially free of added effective blowing agent.

Embodiment 3. Hollow microspheres according to embodiment 2 wherein essentially free of added effective blowing agent includes less than 0.05 wt % of an added effective blowing agent based on the total weight of the feed composition from which the hollow microspheres are derived.

Embodiment 4. Hollow microspheres according to any of the preceding embodiments wherein the hollow microspheres have a density of less than about 1.0 g/cm³.

Embodiment 5. Hollow microspheres according to any of the preceding embodiments wherein the feed composition further comprises at least one of boron oxide and boric acid.

Embodiment 6. Hollow microspheres according to embodiment 1, 2, 3, 4, or 5 wherein the hollow microspheres have a strength of greater than about 30 MPa.

Embodiment 7. Hollow microspheres according to embodiment 1, 2, 3, 4, or 5 wherein the hollow microspheres have a strength of greater than about 50 MPa.

Embodiment 8. Hollow microspheres according to embodiment 1, 2, 3, 4, or 5 wherein the hollow microspheres have a strength of greater than about 80 MPa.

Embodiment 9. Hollow microspheres according to embodiment 1, 2, 3, 4, or 5 wherein the hollow microspheres have a strength of greater than about 90 MPa.

Embodiment 10. Hollow microspheres according to embodiment 1, 2, 3, 4, or 5 wherein the hollow microspheres have a strength of greater than about 100 MPa.

Embodiment 11. Hollow microspheres comprising: a blend of recycled glass and glass feed, wherein the hollow microspheres have a density of less than 1.25 g/cm³ and are made from a feed essentially free of an added effective blowing agent.

Embodiment 12. Hollow microspheres according to embodiment 11 wherein the hollow microspheres have a density of less than about 1.0 g/ml.

Embodiment 13. Hollow microspheres according to embodiment 11 or 12 wherein essentially free of added effective blowing agent includes less than 0.12 wt % of an added effective blowing agent based on the total weight of the feed composition from which the hollow microspheres are derived.

Embodiment 14. Hollow microspheres according to embodiment 11, 12 or 13 wherein the weight percent of recycled glass is greater than or equal to 45 wt % based on the total weight of the feed composition from which the hollow microspheres are derived.

Embodiment 15. Hollow microspheres according to any of embodiment 11, 12, 13 or 14 wherein the hollow microspheres have a substantially single cell structure.

Embodiment 16. Hollow microspheres according to embodiment 11, 12, 13, 14 or 15 wherein the hollow microspheres have a strength of greater than about 20 MPa.

Embodiment 17. Hollow microspheres according to embodiment 11, 12, 13, 14 or 15 wherein the hollow microspheres have a strength of greater than about 30 MPa.

Embodiment 18. Hollow microspheres according to embodiment 11, 12, 13, 14 or 15 wherein the hollow microspheres have a strength of greater than about 50 MPa.

Embodiment 19. Hollow microspheres according to embodiment 11, 12, 13, 14 or 15 wherein the hollow microspheres have a strength of greater than about 80 MPa.

Embodiment 20. Hollow microspheres according to embodiment 11, 12, 13, 14 or 15 wherein the hollow microspheres have a strength of greater than about 90 MPa.

Embodiment 21. Hollow microspheres according to embodiment 11, 12, 13, 14 or 15 wherein the hollow microspheres have a strength of greater than about 100 MPa.

Embodiment 22. Method of making hollow microspheres comprising:

providing a feed composition comprising recycled glass particles,

forming an aqueous dispersion of recycled glass particles and at least one of boric acid and boron oxide,

spray drying the aqueous dispersion to form spherical glass agglomerates, and

heating the agglomerates to form hollow microspheres,

wherein the hollow microspheres have a substantially single cell structure.

Embodiment 23. Method of making hollow microspheres according to embodiment 22 wherein the hollow microspheres have a density of less than 1.25 g/cm³ and strength at 20% volume reduction greater than 20 MPa.

Embodiment 24. Method of making hollow microspheres according to embodiment 22 or 23, wherein the feed composition is essentially free of an added effective blowing agent.

Embodiment 25. Method of making hollow microspheres according to embodiment 22 or 23, wherein the feed composition comprises at least 45 wt % of recycled glass based on the total weight of the feed composition.

The following specific, but non-limiting, examples will serve to illustrate the invention. In these examples, all amounts are expressed in parts by weight unless specified otherwise.

### Materials:

Recycled glass: tricolored recycled container glass (80 mesh), white (flint), amber and emerald green (green) recycled glasses were obtained from Strategic Materials Inc., Texas, USA.

Glass frit: glass frit was prepared by combining the following components: SiO₂ (60.32 weight percent (wt %)), Na₂O 0.2B₂O₃ (14.2 lwt %), CaCO₃ (20.1 wt %), Na₂CO₃ (3.53 wt %), Na₂SO₄ (0.59 wt %), and Na₄P₂O₇ (1.25 wt %). The mixture was melted at approximately 1350° C. in a glass tank. The molten glass was then streamed from the tank into agitated chilled water.

Glass feed was prepared by partially crushing the glass frit using a disc mill (available under the trade designation “PULVERIZING DISC MILL” from Bico, Inc., Burbank, Calif.) equipped with ceramic discs and having a 0.030-inch (0.762-mm) outer gap.

Boron oxide: obtained from Merck & Co, Whitehouse Station, N.J.

Boric acid: obtained from EMD Chemicals, Gibbstown, N.J.

“CELLGUM”: carboxymethylcellulose (CMC) obtained from Ashland Aqualon, Wilmington, Del.

Portland cement: obtained from Lafarge Canada Inc., Alberta, Canada.

Sugar: obtained from Domino Food Inc., Yonkers, N.Y.

Fly ash: obtained from Boral Material Technologies Inc., San Antonio, Tex.

### Test Methods

Average Particle Density Determination

A fully automated gas displacement pycnometer obtained under the trade designation “Accupyc 1330 Pycnometer” from Micromeritics, Norcross, Ga., was used to determine the density of microspheres according to ASTM D2840-69, “Average True Particle Density of Hollow Microspheres”.

Particle Size Determination

Particle size distribution was determined using a particle size analyzer available under the trade designation “Coulter Counter LS-130” from Beckman Coulter, Fullerton, Calif.

Strength Test

The strength of the hollow microspheres was measured using ASTM D3102-72; “Hydrostatic Collapse Strength of Hollow Glass Microspheres” with the exception that the sample size of hollow microspheres is 10 mL, the hollow microspheres are dispersed in glycerol (20.6 g) and data reduction was automated using computer software. The value reported is the hydrostatic pressure at which 20 percent by volume of the raw product collapses.

### EXAMPLES

In some of the following Comparative Examples and Examples, white (flint), amber and emerald green (green) recycled glasses were used. Composition, as provided by the supplier, of the recycled glasses in weight percent (wt %) is listed in Table 1, below.

TABLE 1
Composition of white, amber and green recycled glasses

| | White recycled | Amber recycled | Green recycled |
|---|---|---|---|
| Components | glass (wt %) | glass (wt %) | glass (wt %) |
| SiO₂ | 73.21 | 72.45 | 72.26 |
| Na₂O | 13.45 | 13.01 | 13.11 |
| CaO | 10.32 | 10.48 | 10.47 |
| Al₂O3 | 1.34 | 1.95 | 2.05 |
| MgO | 1.04 | 0.68 | 0.78 |
| K₂O | 0.4 | 0.44 | 0.93 |
| SO₃ | 0.16 | 0.08 | 0.08 |
| Fe₂O₃ | 0.081 | 0.31 | 0.205 |
| Cr₂O₃ | 0.0026 | 0 | 0.12 |

### Comparative Examples A1-A15

Comparative hollow glass microspheres were prepared according to the following description: recycled glass particles (white, amber or green) were milled in 700 g increments to an average particle size of about 20 μm using a fluidized bed jet mill (available under the trade designation “Alpine Model 100 APG” from Hosokawa Micron Powder Systems, Summit, N.J.). An effective blowing agent (Na₂SO₄) and at least one of boron oxide (B₂O₃) or boric acid (B(OH)₃) were added to the aqueous solution of milled particles (30 wt % to 50 wt % solids) and mixed using an air driven mixer. The mixture was milled using a media mill (commercially available under the trade designation “LABSTAR” from NETZSCH Fine Particle Technology, Exton, Pa.) and 1 mm yttrium-stabilized zirconium oxide grinding beads (commercially available from NETZSCH Fine Particle Technology) for 2 hours. The milling speed was of about 2000 rpm. The mixture was subsequently spray dried using a spray dryer commercially available under the trade designation “NIRO MOBILE MINOR” (from GEA Process Engineering, Hudson, Wis.) to form spherical agglomerates. The spray dryer conditions were: input air heated to about 250° C., air pressure to the spin head of about 4.5-5.5 bar (450-550 kPa), and a pump speed of about 65-80 ml/min. The spray-dried agglomerates were then passed through a natural gas/air, or natural gas/air/oxygen flame, as generally described in PCT Patent Publication No. WO2006/062566 (Marshall), incorporated herein by reference. The air, gas and oxygen flow rates in liters per minute (1/min) are reported in Table 2, below. The flame-formed hollow glass microspheres were collected and their density and strength measured according to the above-described test methods.

Composition (in weight percent (wt %)) and flame forming process conditions for the comparative hollow glass microspheres prepared in Comparative Examples A1-A15 are shown in Table 2, below.

TABLE 2
Composition and process conditions for Comparative Examples A1-A15.

| | Type of | Composition | | | | Process conditions | | |
|---|---|---|---|---|---|---|---|---|
| Comparative | recycled | Recycled | Na₂SO₄ | B₂O₃ | B(OH)₃ | Air | Gas | Oxygen |
| Examples | glass | glass (wt %) | (wt %) | (wt %) | (wt %) | (l/min) | (l/min) | (l/min) |
| Comp. Ex. A1 | White | 89.29 | 1.79 | 8.93 | 0.00 | 265 | 30 | 0 |
| Comp. Ex. A2 | White | 93.46 | 1.87 | 4.67 | 0.00 | 265 | 30 | 0 |
| Comp. Ex. A3 | White | 92.31 | 3.07 | 4.62 | 0.00 | 265 | 30 | 0 |
| Comp. Ex. A4 | White | 88.24 | 2.94 | 8.82 | 0.00 | 265 | 30 | 0 |
| Comp. Ex. A5 | Green | 89.29 | 1.79 | 8.93 | 0.00 | 241 | 30 | 5 |
| Comp. Ex. A6 | Green | 89.29 | 1.79 | 8.93 | 0.00 | 265 | 30 | 0 |
| Comp. Ex. A7 | Green | 89.29 | 1.79 | 8.93 | 0.00 | 285 | 30 | 0 |
| Comp. Ex. A8 | Green | 89.29 | 1.79 | 8.93 | 0.00 | 300 | 30 | 0 |
| Comp. Ex. A9 | Amber | 89.29 | 1.79 | 8.93 | 0.00 | 241 | 30 | 5 |
| Comp. Ex. A10 | Amber | 89.29 | 1.79 | 8.93 | 0.00 | 265 | 30 | 0 |
| Comp. Ex. A11 | Amber | 89.29 | 1.79 | 8.93 | 0.00 | 285 | 30 | 0 |
| Comp. Ex. A12 | Amber | 89.29 | 1.79 | 8.93 | 0.00 | 300 | 30 | 0 |
| Comp. Ex. A13 | White | 82.92 | 1.66 | 0.00 | 15.42 | 241 | 30 | 5 |
| Comp. Ex. A14 | White | 82.92 | 1.66 | 0.00 | 15.42 | 265 | 30 | 0 |
| Comp. Ex. A15 | White | 82.92 | 1.66 | 0.00 | 15.42 | 285 | 30 | 0 |

Density and strength results are reported in Table 3, below.

TABLE 3
Density and strength of comparative hollow glass microspheres.

| Comparative Examples | Density (g/cm³) | Strength (MPa) |
|---|---|---|
| Comparative Example A1 | 0.65 | 9.36 |
| Comparative Example A2 | 1.16 | Not measured |
| Comparative Example A3 | 1.40 | Not measured |
| Comparative Example A4 | 1.26 | Not measured |
| Comparative Example A5 | 0.69 | 7.26 |
| Comparative Example A6 | 0.63 | 5.52 |
| Comparative Example A7 | 0.59 | 4.20 |
| Comparative Example A8 | 0.54 | 4.00 |
| Comparative Example A9 | 0.79 | 7.33 |
| Comparative Example A10 | 0.70 | 4.83 |
| Comparative Example A11 | 0.66 | 3.82 |
| Comparative Example A12 | 0.63 | 3.51 |
| Comparative Example A13 | 0.52 | 6.11 |
| Comparative Example A14 | 0.46 | 8.34 |
| Comparative Example A15 | 0.49 | 12.69 |

### Comparative Examples B1-B9

Comparative hollow glass microspheres were prepared as described in Comparative Examples A1-A15 using recycled glass particles except that at least one of the following additives was used: portland cement, sugar and fly ash.

Composition (in wt %) and flame forming process conditions of the comparative hollow glass microspheres prepared in Comparative Examples B1-B9 are shown in Table 4, below.

TABLE 4
Composition and process conditions for Comparative Examples B1-B9.

| | | Composition | | | | | | |
|---|---|---|---|---|---|---|---|---|
| | Type of | Recycled | | | | Process conditions | | |
| Comparative | recycled | glass | Cement | Sugar | Fly ash | Air | Gas | Oxygen |
| Examples | glass | (wt %) | (wt %) | (wt %) | (wt %) | (l/m) | (l/m) | (l/m) |
| Comp. Ex. | Tricolor | 90.91 | 9.09 | 0.00 | 0.00 | 265 | 30 | 0 |
| B1 | | | | | | | | |
| Comp. Ex. | Tricolor | 90.91 | 9.09 | 0.00 | 0.00 | 285 | 30 | 0 |
| B2 | | | | | | | | |
| Comp. Ex. | Tricolor | 90.91 | 9.09 | 0.00 | 0.00 | 241 | 30 | 5 |
| B3 | | | | | | | | |
| Comp. Ex. | Tricolor | 98.04 | 0.00 | 1.96 | 0.00 | 265 | 30 | 0 |
| B4 | | | | | | | | |
| Comp. Ex. | Tricolor | 98.04 | 0.00 | 1.96 | 0.00 | 285 | 30 | 0 |
| B5 | | | | | | | | |
| Comp. Ex. | Tricolor | 98.04 | 0.00 | 1.96 | 0.00 | 241 | 30 | 5 |
| B6 | | | | | | | | |
| Comp. Ex. | Tricolor | 90.09 | 0.00 | 0.90 | 9.01 | 265 | 30 | 0 |
| B7 | | | | | | | | |
| Comp. Ex. | Tricolor | 90.09 | 0.00 | 0.90 | 9.01 | 285 | 30 | 0 |
| B8 | | | | | | | | |
| Comp. Ex. | Tricolor | 90.09 | 0.00 | 0.90 | 9.01 | 241 | 30 | 5 |
| B9 | | | | | | | | |

Density of comparative hollow glass microspheres was measured and is reported in Table 5, below.

TABLE 5
Density of comparative hollow glass microspheres.

| Comparative Examples | Density (g/cm³) |
|---|---|
| Comparative Example B1 | 1.8828 |
| Comparative Example B2 | 2.0500 |
| Comparative Example B3 | 1.9265 |
| Comparative Example B4 | 1.8309 |
| Comparative Example B5 | 1.8189 |
| Comparative Example B6 | 1.9578 |
| Comparative Example B7 | 2.2754 |
| Comparative Example B8 | 2.2460 |
| Comparative Example B9 | 2.2401 |

### Examples 1-8

Hollow glass microspheres of Examples 1-8 were prepared as described in Comparative Examples A1-A15, except that no effective blowing agent was added to the feed composition. Composition and flame forming process conditions of the hollow glass microspheres prepared in Examples 1-8 are shown in Table 6, below.

TABLE 6
Composition and process conditions for Examples 1-8.

| | | Composition | | | Process conditions | | |
|---|---|---|---|---|---|---|---|
| | Type of | Recycled | B₂O₃ | | Air | Gas | |
| | recycled | glass | (wt | B(OH)₃ | (l/ | (l/ | Oxygen |
| Examples | glass | (wt %) | %) | (wt %) | min) | min) | (l/min) |
| Example 1 | White | 90.91 | 9.09 | 0.00 | 265 | 30 | 0 |
| Example 2 | White | 90.91 | 9.09 | 0.00 | 241 | 30 | 5 |
| Example 3 | White | 90.91 | 9.09 | 0.00 | 217 | 30 | 10 |
| Example 4 | White | 90.91 | 9.09 | 0.00 | 194 | 30 | 15 |
| Example 5 | White | 90.91 | 9.09 | 0.00 | 170 | 30 | 20 |
| Example 6 | White | 84.32 | 0.00 | 15.68 | 285 | 30 | 0 |
| Example 7 | White | 84.32 | 0.00 | 15.68 | 265 | 30 | 0 |
| Example 8 | White | 84.32 | 0.00 | 15.68 | 241 | 30 | 5 |

Density and strength were measured and results are reported in Table 7, below.

TABLE 7
Density and strength of hollow glass microspheres
prepared as described in Examples 1-8.

| Examples | Density (g/cm³) | Strength (MPa) |
|---|---|---|
| Example 1 | 1.23 | 62.23 |
| Example 2 | 1.08 | 111.31 |
| Example 3 | 1.03 | 148.52 |
| Example 4 | 0.89 | 126.35 |
| Example 5 | 0.92 | 174.22 |
| Example 6 | 0.64 | 82.74 |
| Example 7 | 0.63 | 91.16 |
| Example 8 | 0.64 | 100.92 |

Size of hollow microspheres of Example 6 was measured using the above-described particle size determination test method. Particle diameter of the hollow microspheres is expressed as a function of cumulative volume. In Example 6, 90% of the prepared hollow microspheres had a particle diameter equal to or less than 39.8 μm; 75% of the hollow microspheres had a particle diameter of equal to or less than 33.2 μm; 50% of the hollow microspheres had a particle diameter of equal to or less than 26.4 μm; 25% of the hollow microspheres had a particle diameter of equal to or less than 18.4 μm; and 10% of the hollow microspheres had a particle diameter of equal to or less than 18.4 μm.

### Comparative Examples C1-C9

Comparative hollow microspheres were prepared according to the following description: recycled glass particles were milled using the fluidized bed jet mill, as described in Comparative Examples A1-A15, to an average particle size of about 20 μm. Glass feed, prepared as described above and CELLGUM binder were added to the aqueous mixture of recycled glass particles. The mixture was subsequently spray dried to form spray-dried agglomerates, as described in Comparative Examples A1-A15, except that no effective blowing agent, boron oxide or boric acid was added. The agglomerates were passed through the natural gas/air, or natural gas/air/oxygen flame to form the comparative hollow glass microspheres. The microspheres were collected and their density and strength measured according to the above-described test methods.

Composition (in weight percent) and flame forming process conditions of the comparative hollow glass microspheres prepared in Comparative Examples C1-C9 are shown in Table 8, below.

TABLE 8
Composition and process conditions for Comparative Examples C1-C9.

| | | | Composition | | | | | |
|---|---|---|---|---|---|---|---|---|
| | | Type of | Recycled | Glass | | Process conditions | | |
| Comparative | Type of | recycled | glass | feed | Binder | Air | Gas | Oxygen |
| Examples | particles | glass | (wt %) | (wt %) | (wt %) | (l/min) | (l/min) | (l/min) |
| Comp. Ex. | Blend | White | 89.11 | 9.90 | 0.99 | 285 | 30 | 23 |
| C1 | | | | | | | | |
| Comp. Ex. | Blend | White | 89.11 | 9.90 | 0.99 | 285 | 30 | 0 |
| C2 | | | | | | | | |
| Comp. Ex. | Blend | White | 89.11 | 9.90 | 0.99 | 176 | 30 | 0 |
| C3 | | | | | | | | |
| Comp. Ex. | Blend | White | 89.11 | 9.90 | 0.99 | 340 | 30 | 0 |
| C4 | | | | | | | | |
| Comp. Ex. | Blend | White | 69.31 | 29.70 | 0.99 | 340 | 30 | 0 |
| C5 | | | | | | | | |
| Comp. Ex. | Blend | White | 69.31 | 29.70 | 0.99 | 285 | 30 | 0 |
| C6 | | | | | | | | |
| Comp. Ex. | Blend | White | 69.31 | 29.70 | 0.99 | 176 | 30 | 0 |
| C7 | | | | | | | | |
| Comp. Ex. | Blend | White | 69.31 | 29.70 | 0.99 | 228 | 30 | 12 |
| C8 | | | | | | | | |
| Comp. Ex. | Blend | Green | 49.50 | 49.50 | 0.99 | 176 | 30 | 23 |
| C9 | | | | | | | | |

Density and strength were measured for comparative hollow glass microspheres prepared as described in Comparative Examples C1-C9 following the test methods described above. Results are reported in Table 9, below.

TABLE 9
Density of comparative hollow glass microspheres

| Comparative Examples | Density (g/cm³) |
|---|---|
| Comparative Example C1 | 1.6647 |
| Comparative Example C2 | 1.6030 |
| Comparative Example C3 | 2.1507 |
| Comparative Example C4 | 1.6163 |
| Comparative Example C5 | 1.6952 |
| Comparative Example C6 | 1.6124 |
| Comparative Example C7 | 1.9536 |
| Comparative Example C8 | 1.6579 |
| Comparative Example C9 | 1.7741 |

### Example 9-18

Hollow microspheres described in Examples 9-18 were prepared as described in Comparative Examples C1-C9, except that blends of recycled glass particles and glass feed were used. Composition (in wt %) and flame forming process conditions of the hollow glass microspheres prepared in Examples 9-18 is shown in Table 10, below.

TABLE 10
Composition and process conditions for Examples 9-18

| | | | Composition | | | | | |
|---|---|---|---|---|---|---|---|---|
| | | Type of | Recycled | | | Process conditions | | |
| | Type of | recycled | glass | Glass feed | Binder | Air | Gas | Oxygen |
| Examples | particles | glass | (wt %) | (wt %) | (wt %) | (l/min) | (l/min) | (l/min) |
| Example 9 | Blend | White | 49.50 | 49.50 | 0.99 | 340 | 30 | 0 |
| Example 10 | Blend | White | 49.50 | 49.50 | 0.99 | 285 | 30 | 0 |
| Example 11 | Blend | White | 49.50 | 49.50 | 0.99 | 285 | 30 | 0 |
| Example 12 | Blend | White | 49.50 | 49.50 | 0.99 | 228 | 30 | 12 |
| Example 13 | Blend | Green | 49.50 | 49.50 | 0.99 | 340 | 30 | 0 |
| Example 14 | Blend | Green | 49.50 | 49.50 | 0.99 | 285 | 30 | 0 |
| Example 15 | Blend | Green | 49.50 | 49.50 | 0.99 | 285 | 30 | 0 |
| Example 16 | Blend | Amber | 49.50 | 49.50 | 0.99 | 340 | 30 | 0 |
| Example 17 | Blend | Amber | 49.50 | 49.50 | 0.99 | 285 | 30 | 0 |
| Example 18 | Blend | Amber | 49.50 | 49.50 | 0.99 | 285 | 30 | 0 |

Density and strength were measured for hollow glass microspheres prepared as described in Examples 9-18 following the test methods described above. Results are reported in Table 11, below.

TABLE 11
Density and strength of hollow glass microspheres
prepared as described in Examples 9-18.

| Examples | Density (g/cm³) | Strength (MPa) |
|---|---|---|
| Example 9 | 0.8151 | 24.18 |
| Example 10 | 0.7737 | 32.78 |
| Example 11 | 0.8131 | 48.97 |
| Example 12 | 1.0703 | 24.18 |
| Example 13 | 0.8806 | 73.37 |
| Example 14 | 0.9208 | 62.46 |
| Example 15 | 0.9541 | 84.52 |
| Example 16 | 0.9655 | 35.30 |
| Example 17 | 0.9364 | 30.77 |
| Example 18 | 0.9529 | 38.07 |

Various modifications and alterations of this invention will become apparent to those skilled in the art without departing from the scope and spirit of this invention.

1. Hollow microspheres comprising: at least 45 wt % of recycled glass based on the total weight of a feed composition from which the hollow microspheres are derived, wherein the hollow microspheres have a true density of less than 1.25 g/cm³, strength at 20% volume reduction greater than 20 MPa and have a substantially single cell structure, further wherein the hollow microspheres are produced from a feed composition having less than 0.05 wt % of an added effective blowing agent based on the total weight of the feed composition from which the hollow microspheres are derived.

2-3. (canceled)

4. Hollow microspheres according to claim 1, wherein the hollow microspheres have a true density of less than about 1.0 g/cm³.

5. Hollow microspheres according to claim 1, wherein the feed composition further comprises at least one of boron oxide and boric acid.

6-9. (canceled)

10. Hollow microspheres according to claim 1, wherein the hollow microspheres have a strength of greater than about 100 MPa.

11-21. (canceled)

22. Method of making hollow microspheres comprising:
providing a feed composition comprising recycled glass particles that comprises less than 0.05 wt % of an added effective blowing agent based on the total weight of the feed composition,
forming an aqueous dispersion of recycled glass particles and at least one of boric acid and boron oxide,
spray drying the aqueous dispersion to form spherical glass agglomerates, and
heating the agglomerates to form hollow microspheres, wherein the hollow microspheres have a substantially single cell structure.

23. Method of making hollow microspheres according to claim 22 wherein the hollow microspheres have a density of less than 1.25 g/cm³ and strength at 20% volume reduction greater than 20 MPa.

24-25. (canceled)
